(19) United States
(12) Patent Application Publication
(10) Pub. No.: US 2015/0031459 A1
(43) Pub. Date: Jan. 29, 2015

(54) PROJECTING UNIT HAVING FUNCTION OF GAME PLATFORM

(71) Applicant: ROBOTIS CO., LTD., Seoul (KR)

(72) Inventor: Byoung-Soo KIM, Seoul (KR)

(73) Assignee: ROBOTIS CO., LTD., Seoul (KR)

(21) Appl. No.: 14/285,569

(22) Filed: May 22, 2014

(30) Foreign Application Priority Data
Jul. 23, 2013 (KR) 10-2013-0086657

(51) Int. Cl. A63F 13/31; A63F 13/21; A63F 13/25

(52) U.S. Cl. CPC A63F 13/31; A63F 13/25; A63F 13/21
USPC 463/40; 463/34; 463/37

(57) ABSTRACT

A project unit having a game platform function by mounting a mobile communication device is provided. The project unit includes a first body unit including a mounting unit configured to detachably mount the mobile communication device, a projector connected to the first body unit and configured to project an image in a predetermined direction, a second body unit coupled to the first body unit and configured to selectively move or rotate, and a control unit electrically connected to the first body unit, the projector, and the second body unit, and configured to control the projector and the second body unit, wherein the projector projects a game image transmitted from the mobile communication device through the control unit, and at least one of the first body unit and the second body unit includes a plurality of plate members which are disassembled and assembled.

### CROSS-REFERENCE TO RELATED APPLICATION

This application claims priority to and the benefit of Korean Patent Application No. 10-2013-0086657, filed on Jul. 23, 2013, the disclosure of which is incorporated herein by reference in its entirety.

### BACKGROUND

1. Field of the Invention The present invention relates to a project unit having a game platform function, and more particularly, to a project unit capable of mounting a mobile communication device and having a function capable of projecting a game image onto an object such as a wall, etc.

2. Discussion of Related Art

Recently, various mobile communication devices combining functions of a personal mobile terminal and a personal computer (PC), such as a smartphone, a smart pad, a tablet PC, etc., have been widely used. Accordingly, various applications capable of being used in the mobile communication devices are actively being developed, and the applications can be easily found in an application market such as Android Market, App Store, etc.

A game field is one of the spotlighted fields in the applications for the mobile communication devices. However, it is difficult for a user to use the game applications due to hardware limitations of the mobile communication devices, for example, limitations of a screen size of a display unit, etc. That is, it is difficult for the user to lively enjoy a game due to a small screen size of the display unit of the mobile communication device in which portability is emphasized. Further, it is inconvenient to enjoy a game in which a plurality of users play using the mobile communication devices, for example, a war-type game or a collaboration game.

Meanwhile, according to developments of robot technology for an education or a game, exclusive robots capable of executing a game or an education program are being developed. However, the exclusive robots do not have sufficient scalability capable of playing various games due to limitations of embedded programs, and particularly, it is inconvenient to use due to the limitations of the screen size of the display unit like the mobile communication devices when an embedded display unit is used.

To solve the problem due to the limitations of the screen size of the display unit, various devices having a project function are being developed. However, there is no device yet capable of easily using various game applications of the mobile communication devices.

### SUMMARY OF THE INVENTION

The present invention is directed to a project unit of a new concept having a game platform function by mounting a mobile communication device.

According to an aspect of the present invention, there is provided a project unit having a game platform function by mounting a mobile communication device, including: a first body unit including a mounting unit configured to detachably mount the mobile communication device; a second body unit coupled to the first body unit, and configured to selectively move or rotate; and a control unit electrically connected to the first body unit and the second body unit, and configured to control the second body unit, wherein at least one of the first body unit and the second body unit includes a plurality of plate members which are disassembled and assembled.

In an embodiment, the project unit may further include a projector connected to the first body unit, and configured to project an image in a predetermined direction, wherein the control unit may control the projector, and the projector may project a game image transmitted from the mobile communication device through the control unit.

In an embodiment, the plate member may include a plurality of coupling holes detachably coupled to a coupler.

In an embodiment, the coupler may include a socket detachably coupling two or more plate members using an elastic force.

In an embodiment, the second body unit may include a wheel, and a motor driving the wheel.

In an embodiment, a projection direction of the projector may be changed by changing a position and an angle of the second body unit by driving the motor.

In an embodiment, at least one of the first body unit and the second body unit may include a frame member or a joint member having a shape imitating a character shape.

In an embodiment, the project unit may further include an external communication unit configured to wirelessly connect to an external mobile communication device, wherein a game control signal may be transmitted from the external mobile communication device through the external communication unit.

### BRIEF DESCRIPTION OF THE DRAWINGS

The above and other objects, features, and advantages of the present invention will become more apparent to those of ordinary skill in the art by describing in detail exemplary embodiments thereof with reference to the accompanying drawings, in which:

FIG. 1 is a diagram illustrating function blocks of a mobile communication device and a project unit according to an exemplary embodiment of the present invention;

FIG. 2 is a diagram illustrating a communication operation between the project unit shown in FIG. 1 and external mobile communication devices;

FIG. 3 is a schematic diagram illustrating appearance of a project unit according to an exemplary embodiment of the present invention;

FIG. 4 is a diagram illustrating a movement operation of the project unit shown in FIG. 3;

FIGS. 5A and 5B are diagrams illustrating an image projection operation of the project unit shown in FIG. 3;

FIG. 6 is a diagram illustrating appearance of a project unit formed of a plate member according to an exemplary embodiment of the present invention;

FIG. 7 is a diagram illustrating an operation of combining a plate member and a coupler according to an exemplary embodiment of the present invention; and

FIG. 8 is a diagram illustrating various shapes of the plate member.

### DETAILED DESCRIPTION OF EXEMPLARY EMBODIMENTS

Exemplary embodiments of the present invention will be described in detail below with reference to the accompanying drawings. While the present invention is shown and described in connection with exemplary embodiments thereof, it will be apparent to those skilled in the art that various modifications can be made without departing from the spirit and scope of the invention. In the accompanying drawings, description which is not related to the present invention will be omitted in order to clearly describe the present invention, and throughout the specification, similar reference numerals are used in similar portions.

Throughout the specification, it will be understood that when an element is referred to as being “connected” or “coupled” to another element, it can be directly connected or coupled to the other element or intervening elements may be present. Further, it will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

The present invention relates to a project unit having a game platform function. Hereinafter, exemplary embodiments of the present invention will be described in detail with reference to the accompanying drawings.

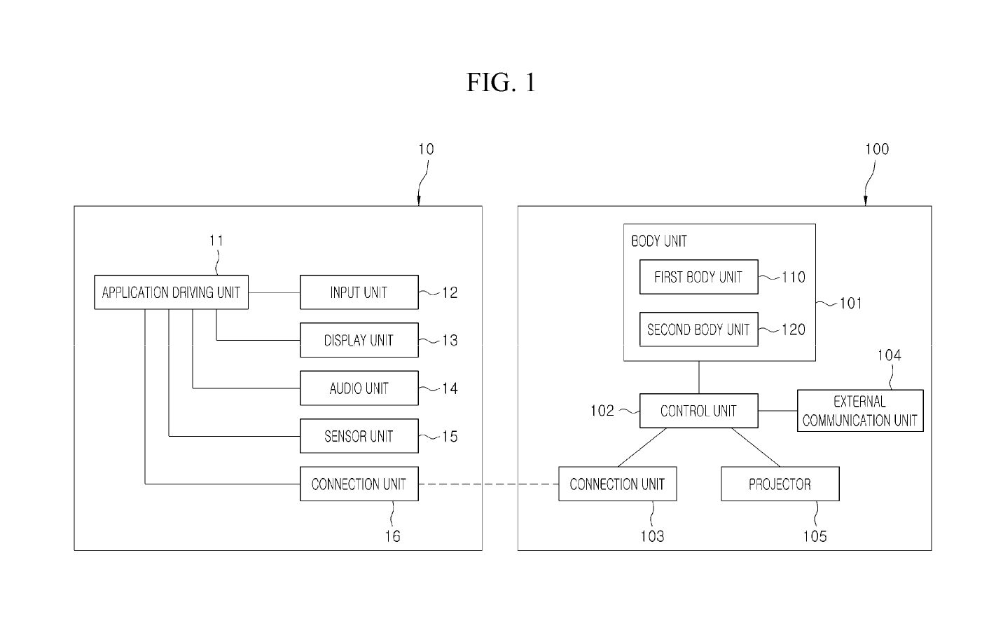

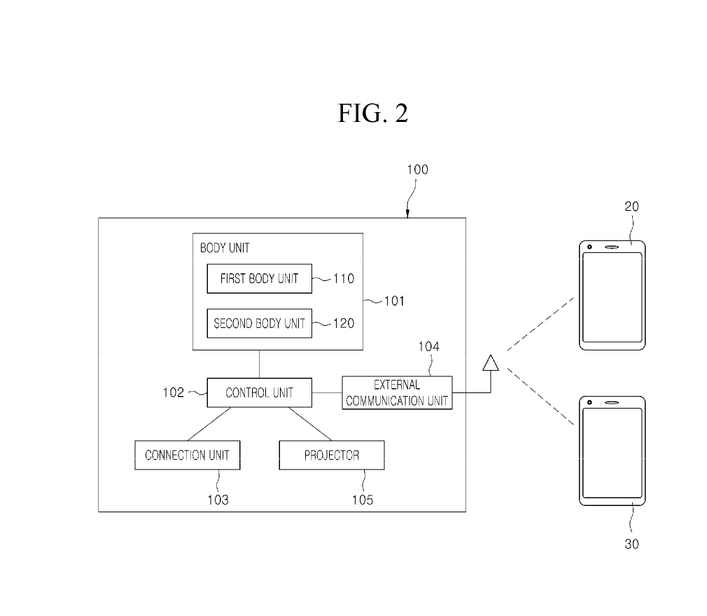

FIG. 1 is a diagram illustrating function blocks of a mobile communication device and a project unit according to an exemplary embodiment of the present invention, and FIG. 2 is a diagram illustrating a communication operation between the project unit shown in FIG. 1 and external mobile communication devices.

Referring to FIG. 1, a mobile communication device 10 may include an application driving unit 11, an input unit 12, a display unit 13, an audio unit 14, a sensor unit 15, and a connection unit 16. The application driving unit 11 may execute and store various applications including a game application. The game application may be embedded in the mobile communication device 10, or be downloaded without charge or with a fee from various application markets, and thus a user can enjoy various games. Here, the mobile communication device 10 may be a portable electronic device having a communication function and a function capable of driving various applications, and may be called at least one of a mobile phone, a smartphone, a smart pad, a portable multimedia player (PMP), or a tablet personal computer (PC), etc. A construction of the mobile communication device 10 is well known, and thus a detailed description thereof will be omitted since it is beyond the scope of the present invention.

A project unit 100 may be electrically connected to the mobile communication device 10 by mounting the mobile communication device 10, and have a game platform function. Here, the mobile communication device 10 indicated as reference numeral 10 may be a device mounted in the project unit 100, and mobile communication devices 20 and 30 which will be described later may be separately outside the project unit 100. The mobile communication devices will be distinguished from each other according to the reference numerals.

The project unit 100 may include a body unit 101, a control unit 102, a connection unit 103, an external communication unit 104, and a projector 105, according to its function.

First, the body unit 101 may form an outer appearance of the project unit 100, and be formed of a resin or a metal plate member. The body unit 101 may include a first body unit 110 having a mounting unit for detachably mounting the mobile communication device 10, and a second body unit 120 being coupled to the first body unit 110 and capable of selectively moving or rotating. A detailed description thereof will be described in detail below.

The control unit 102 may be electrically connected to the first body unit 110, the second body unit 120, the connection unit 103, the external communication unit 104, and the projector 105, and control them by receiving and transmitting a command signal and data. Although not shown, the control unit 102 may include a microcontroller and a memory.

The control unit 102 may be electrically connected to the mobile communication device 10 through the connection unit 103. Specifically, the connection unit 103 of the project unit 100 and the connection unit 16 of the mobile communication device 10 may be connected through a wired or wireless interface, and the wired or wireless interface may be a connection terminal with a pin shape, a universal serial bus (USB) connector, an infrared port, a Bluetooth port, a wireless local area network (LAN) port, etc. However, it may not be limited thereto. A game image provided from the application driving unit 11 of the mobile communication device 10 may be transmitted to the project unit 100 by the connection. The transmitted game image may be projected onto a separate object by the projector 105 which will be described below.

The external communication unit 104 may be electrically connected to the external mobile communication device separated outside the project unit 100, and receive information needed for controlling and executing a game application which is currently being executed or will be executed from the external mobile communication device.

Referring to FIG. 2, the external communication unit 104 of the project unit 100 may be electrically connected to the external mobile communication devices 20 and 30. Here, the project unit 100 may be a kind of a game interface device, and the external mobile communication devices 20 and 30 may be game controllers. That is, the project unit 100 may receive a game control signal from the external mobile communication devices 20 and 30 through the external communication unit 104.

In FIG. 2, two external mobile communication devices 20 and 30 are illustrated, but the number of the external mobile communication devices may be 1, or equal to or more than 3. When a plurality of users play a game using the external mobile communication devices 20 and 30, it is possible to lively enjoy a war-type game or a collaboration game requiring two or more users through a large screen.

Further, the user may perform direction controls, various operation commands, movements of menu keys, etc. of a game character in a game application using an input unit (a touchscreen or various keys) of the external mobile communication devices 20 and 30.

Meanwhile, since the mobile communication device which is recently being commercialized includes a position sensor or an acceleration sensor, etc., it is possible to control the game without an additional key input from the mobile communication device using the sensors. For example, when a tri-axis terrestrial magnetism sensor or a tri-axis acceleration sensor is used as the position sensor or the acceleration sensor, it may recognize a position, a pitch angle, a yaw angle, and a roll angle in a three-dimensional space of the mobile communication device by just moving the mobile communication device itself. Accordingly, operations for controlling the game of the user may be reflected in the game application without an additional key input.

Referring to FIG. 1 again, the project unit 100 may include the projector 105. The projector 105 may be connected to the first body unit 110 and project an image in a predetermined direction. That is, the projector 105 may project a game image transmitted from the mobile communication device 10 onto a separate object, for example, a wall, a ceiling, furniture, a screen, etc.

The projector 105 may be configured as an array of various optical components (lenses, etc.) to project by expanding an image, and no more description will be provided since the detailed structure thereof is well known.

By including the projector 105, the user may lively enjoy the game while watching the game image of a large screen projected to the separate object. Specifically, two or more users can enjoy the game by using their own mobile communication devices 20 and 30 as game controllers.

The schematic function blocks of the project unit 100 were described above. However, other blocks may be additionally included in the project unit 100. For example, the project unit 100 may include a speaker, various keys (a power key, a volume control key, etc.), a light emitting device, etc.

Next, an operation of the project unit 100 according to the present invention will be described below.

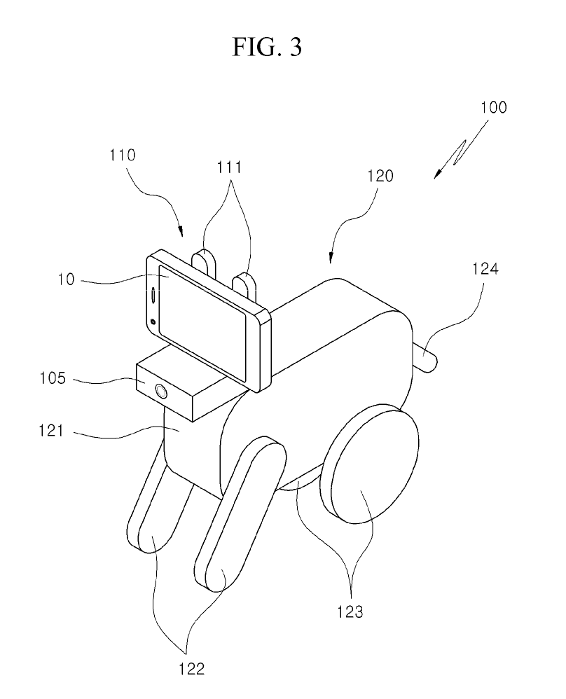

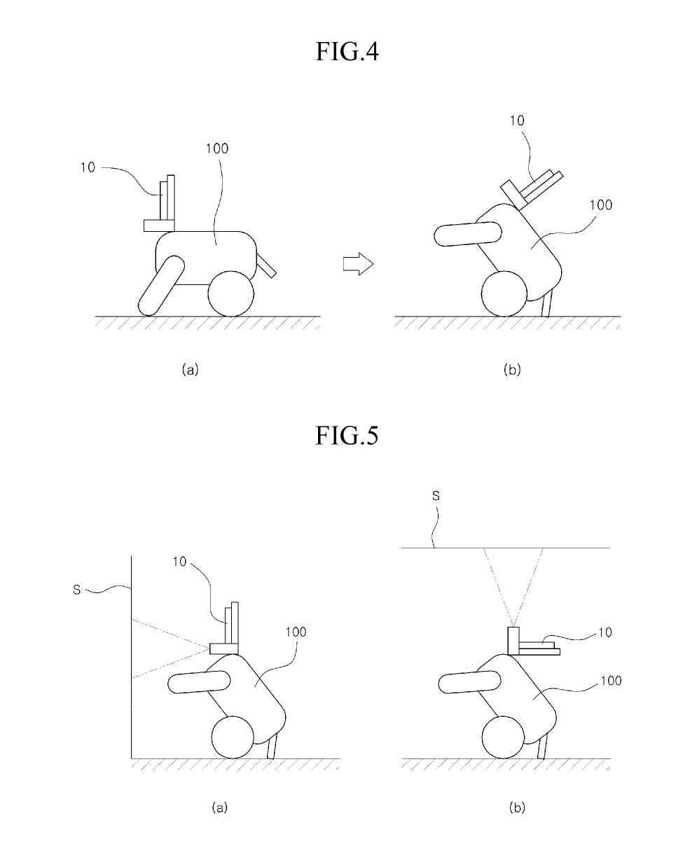

FIG. 3 is a schematic diagram illustrating appearance of a project unit according to an exemplary embodiment of the present invention, FIG. 4 is a diagram illustrating a movement operation of the project unit shown in FIG. 3, and FIGS. 5A and 5B are diagrams illustrating an image projection operation of the project unit shown in FIG. 3.

As shown in FIG. 3, the project unit 100 may include the first body unit 110 having a mounting unit 111 for detachably mounting the mobile communication device 10, and the second body unit 120 being coupled to the first body unit 110. Although not shown, the first body unit 110 and the second body unit 120 may be movably or rotatably coupled by a joint member.

As shown, the project unit 100 may have a dog-like appearance. Further, the first body unit 110 or the second body unit 120 may be configured as a frame member or a joint member to have a character shape such as various animals or cartoon heroines, etc. The frame member or the joint member may be implemented by using plate members, etc. which can be disassembled and assembled. A detailed description thereof will be described below.

Referring to FIG. 3 again, the first body unit 110 may include the mounting unit 111 mounting the mobile communication device 10 and having a shape imitating a dog face. The projector 105 for expanding and projecting an image may be prepared below the mounting unit 111.

A body member 121 may be prepared in the second body unit 120. Further, various frame members or joint members which are coupled to the body member 121, for example, legs members 122, wheel members 123, and a tail member 124, may be prepared in the second body unit 120. The wheel members 123 may have a shape imitating rear legs of the dog, and move and rotate the second body unit 120. Although not shown, a motor for driving the wheel members 123 may be embedded inside the second body unit 120. A projection direction of the projector 105 may be changed by changing a position and an angle of the second body unit 120 by driving the motor.

Referring to FIG. 4, the project unit 100 having the dog-like appearance may be changed from a sitting form to a standing form by properly controlling and driving the motor. Of course, the reverse may be also possible.

Referring to FIGS. 5A and 5B, it can be known that the project direction of the image may be changed by changing the position and the angle of the project unit 100. Thus, it may be possible for the user to project a game image in a desired direction by adding mobility to the project unit 100. FIG. 5A is a drawing illustrating that the image is projected onto a vertical shape object S such as a wall, and FIG. 5B is a drawing illustrating that the image is projected onto a horizontal shape object S such as a ceiling.

Next, appearance of the project unit according to the present invention will be described in detail. Since the project unit having the dog-like appearance was described above, the shape will be described in detail below using the project unit having the dog-like appearance. In addition, the body unit may be formed as various shapes that a user wants.

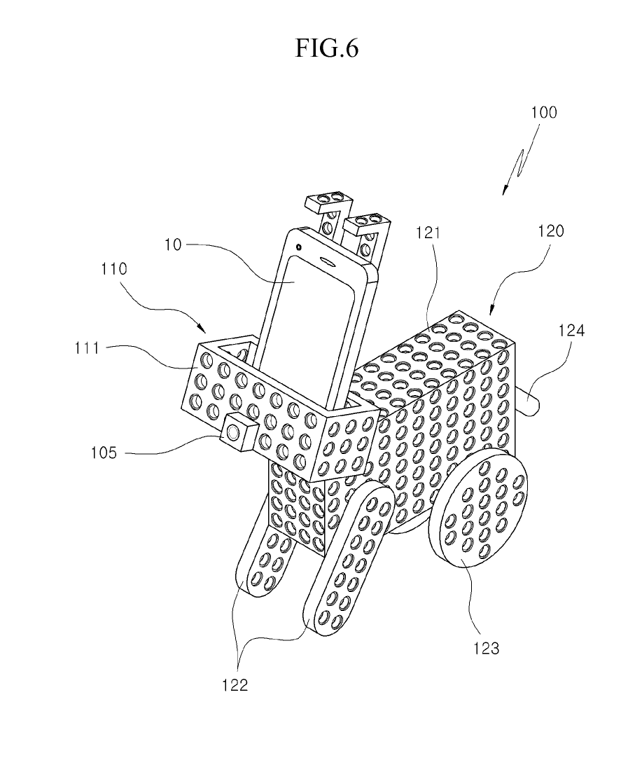

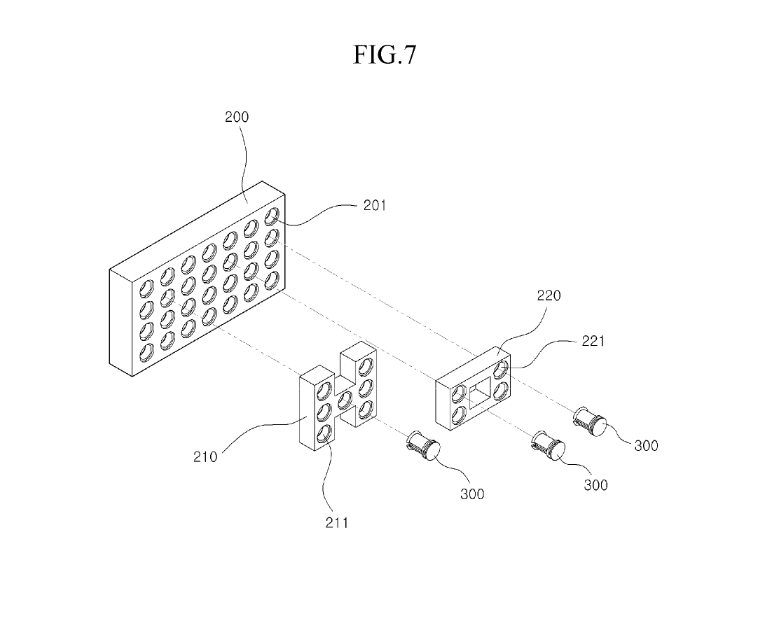

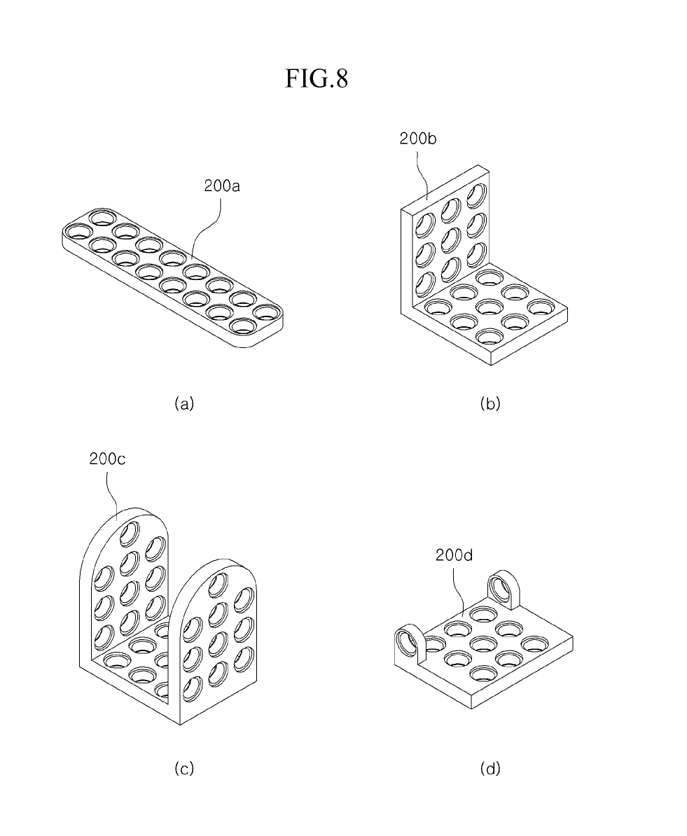

FIG. 6 is a diagram illustrating appearance of a project unit formed of a plate member according to an exemplary embodiment of the present invention, and FIG. 7 is a diagram illustrating an operation of combining a plate member and a coupler according to an exemplary embodiment of the present invention, and FIG. 8 is a diagram illustrating various shapes of the plate member.

As shown in FIG. 6, the first body unit 110 and the second body unit 120 constituting the body of the project unit 100 may be configured of a plate member 200 which can be disassembled and assembled (refer to FIG. 7). Specifically, the mounting unit 111 constituting the first body unit 110 of the project unit 100 and mounting the mobile communication device 10 may be configured of the plate member 200, and the body member 121 and the leg members 122 constituting the second body unit 120 may be configured of the plate member 200.

Referring to FIG. 7, a plurality of coupling holes 201 may be prepared in the plate member 200. As shown, the plurality of coupling holes 201 may be arranged in a matrix form along a plurality of row and columns, and couplers 300 may be detachably coupled to the plurality of coupling holes 201. That is, two or more plate members 200, 210, and 220 may be coupled with each other by inserting and coupling the coupler 300 to the coupling hole 201 prepared in the plate member 200 and coupling holes 211 and 221 prepared in separate plate members 210 and 220.

That is, the two or more plate members 200, 210, and 220 may be coupled with each other by inserting the coupler 300 into the coupling holes 201, 211, and 221 having the same shape prepared in the two or more plate members 200, 210, and 220. The coupler 300 may include a socket with an elastic force being capable of detachably coupling the two or more plate members 200, 210, and 220.

As shown in FIG. 8, plate members 200a, 200b, 200c, and 200d with various shapes may be used, and the shape may not be limited to the illustrated shapes. The plate members 200a, 200b, 200c, and 200d may be resin or metal members in which a plurality of coupling holes are formed, and may function as components constituting a character themselves or may function as members for coupling another component to the project unit 100. The user may make appearance of the project unit 100 as desired using the plate members 200a, 200b, 200c, and 200d with various shapes.

As described above, the project unit according to the exemplary embodiments of the present invention has a game platform function by mounting the mobile communication device. Further, the user can enjoy various games as desired, and lively enjoy the game in a large screen using the projector. Particularly, it may be useful when two or more users play the game. Moreover, the user can make the body as various character shapes by constituting the body of the project unit by the plate members which can be disassembled and assembled.

According to the present invention, the project unit having the game platform function by mounting the mobile communication device may be provided.

According to the present invention, the user can enjoy various games as desired, and lively enjoy the game in a large screen using the projector. Further, the user can make the body as various shapes by constituting the body of the project unit by the plate members which can be disassembled and assembled. For example, the body may be made to have various character shapes such as animals, cartoon heroines, etc.

Further, according to the present invention, the user can project the game image in a desired direction by adding mobility to the project unit. Moreover, an additional mobile communication device can be used as a game controller by utilizing the project unit as a kind of a game interface device.

Effects of the present invention may not be limited thereto, and it should be understood as including all effects which can be inferred from constructions described in the detailed description or claims of the present invention.

It will be apparent to those skilled in the art that various modifications can be made to the above-described exemplary embodiments of the present invention without departing from the spirit or scope of the invention. Thus, it should be understood that the above-described exemplary embodiments of the present invention are illustrative and are not limiting in all respects. For example, each component described in a single type may be implemented in divided types, and similarly, components described in the divided types may be implemented in a combined type.

Thus, it is intended that the present invention covers all such modifications provided they come within the scope of the appended claims and their equivalents.

What is claimed is:

1. A project unit having a game platform function by mounting a mobile communication device, comprising:
a first body unit including a mounting unit configured to detachably mount the mobile communication device;
a second body unit coupled to the first body unit, and configured to selectively move or rotate; and
a control unit electrically connected to the first body unit and the second body unit, and configured to control the second body unit,
wherein at least one of the first body unit and the second body unit includes a plurality of plate members which are disassembled and assembled.

2. The project unit of claim 1, further comprising a projector connected to the first body unit, and configured to project an image in a predetermined direction,
wherein the control unit controls the projector, and the projector projects a game image transmitted from the mobile communication device through the control unit.

3. The project unit of claim 1, wherein the plate member includes a plurality of coupling holes detachably coupled to a coupler.

4. The project unit of claim 3, wherein the coupler includes a socket detachably coupling two or more plate members using an elastic force.

5. The project unit of claim 2, wherein the second body unit includes a wheel, and a motor driving the wheel.

6. The project unit of claim 5, wherein a projection direction of the projector is changed by changing a position and an angle of the second body unit by driving the motor.

7. The project unit of claim 1, wherein at least one of the first body unit and the second body unit includes a frame member or a joint member having a shape imitating a character shape.

8. The project unit of claim 1, further comprising an external communication unit configured to wirelessly connect to an external mobile communication device,
wherein a game control signal is transmitted from the external mobile communication device through the external communication unit.
